(19) United States
(12) Patent Application Publication
(10) Pub. No.: US 2015/0088515 A1
(43) Pub. Date: Mar. 26, 2015

(54) PRIMARY SPEAKER IDENTIFICATION FROM AUDIO AND VIDEO DATA

(71) Applicant: Lenovo (Singapore) Pte. Ltd., Singapore (SG)

(72) Inventors: Suzanne Marion Beaumont, Wake Forest, NC (US); James Anthony Hunt, Chapel Hill, NC (US); Robert James Kapinos, Durham, NC (US); Axel Ramirez Flores, Cary, NC (US); Rod D. Waltermann, Rougemont, NC (US)

(73) Assignee: Lenovo (Singapore) Pte. Ltd., Singapore (SG)

(21) Appl. No.: 14/036,728

(22) Filed: Sep. 25, 2013

(51) Int. Cl. G10L 17/22

(52) U.S. Cl. CPC G10L 17/22
USPC 704/251

(57) ABSTRACT

An aspect provides a method, including: receiving image data from a visual sensor of an information handling device; receiving audio data from one or more microphones of the information handling device; identifying, using one or more processors, human speech in the audio data; identifying, using the one or more processors, a pattern of visual features in the image data associated with speaking; matching, using the one or more processors, the human speech in the audio data with the pattern of visual features in the image data associated with speaking; selecting, using the one or more processors, a primary speaker from among matched human speech; assigning control to the primary speaker; and performing one or more actions based on audio input of the primary speaker. Other aspects are described and claimed.

### BACKGROUND

Information handling devices (“devices”), for example desktop computers, laptop computers, tablets, smart phones, e-readers, etc., often used with applications that process audio. For example, such devices are often used to connect to a web-based or hosted conference call wherein users communicate voice data, often in combination with other data (e.g., documents, web pages, video feeds of the users, etc.). As another example, many devices, particularly smaller mobile user devices, are equipped with a virtual assistant application which responds to voice commands/queries.

Often such devices are used in a crowded audio environment, e.g., more than one person speaking in the environment detectable by the device or component thereof, e.g., microphone(s). While typically devices perform satisfactorily in un-crowded audio environments (e.g., single user scenarios), issues may arise when the audio environment is more complex (e.g., more than one speaker, more than one audio source (e.g., radio, television, other device(s), and the like)).

### BRIEF SUMMARY

In summary, one aspect provides a method, comprising: receiving image data from a visual sensor of an information handling device; receiving audio data from one or more microphones of the information handling device; identifying, using one or more processors, human speech in the audio data; identifying, using the one or more processors, a pattern of visual features in the image data associated with speaking; matching, using the one or more processors, the human speech in the audio data with the pattern of visual features in the image data associated with speaking; selecting, using the one or more processors, a primary speaker from among matched human speech; assigning control to the primary speaker; and performing one or more actions based on audio input of the primary speaker.

Another aspect provides an information handling device, comprising: a visual sensor; one or more microphones; one or more processors; and a memory storing code executable by the one or more processors to: receive image data from the visual sensor; receive audio data from the one or more microphones; identify human speech in the audio data; identify a pattern of visual features in the image data associated with speaking; match the human speech in the audio data with the pattern of visual features in the image data associated with speaking; select a primary speaker from among matched human speech; assign control to the primary speaker; and perform one or more actions based on audio input of the primary speaker.

A further aspect provides a program product, comprising: a computer readable storage medium storing instructions executable by one or more processors, the instructions comprising: computer readable program code configured to receive image data from a visual sensor of an information handling device; computer readable program code configured to receive audio data from one or more microphones of the information handling device; computer readable program code configured to identify, using one or more processors, human speech in the audio data; computer readable program code configured to identify, using the one or more processors, a pattern of visual features in the image data associated with speaking; computer readable program code configured to match, using the one or more processors, the human speech in the audio data with the pattern of visual features in the image data associated with speaking; computer readable program code configured to select, using the one or more processors, a primary speaker from among matched human speech; computer readable program code configured to assign control to the primary speaker; and computer readable program code configured to perform one or more actions based on audio input of the primary speaker.

Another aspect provides an information handling device, comprising: a visual sensor; two or more microphones; one or more processors; and a memory storing code executable by the one or more processors to: receive image data from the visual sensor; receive audio data from the two or more microphones; identify human speech in the audio data; identify a pattern of visual features in the image data associated with speaking utilizing directional information in the audio data received to identify the pattern of visual features associated with speaking; match the human speech in the audio data with the pattern of visual features in the video data associated with speaking; identify matched human speech as a primary speaker; and perform one or more actions based on the primary speaker identified.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of primary speaker identification from audio and video data.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Identifying the current or primary speaker from a group of speakers or an otherwise crowded audio field or environment may be problematic. For example, where more than one speaker (human or otherwise, e.g., radio) is detectable in speech, audio analysis alone may not be able to distinguish which speaker is real (i.e., human, live) and even if so, which of the human speakers (assuming more than one is present) should be considered or identified as the primary speaker, e.g., the one to use for data processing and action execution (e.g., executing a command or query with a virtual assistant).

Some solutions seek to identify a single voice through comparison with stored samples, typically through a one-time comparison. Such solutions fail to consider the more crowded sound field, where several voices are present and a single voice must be selected. Some other solutions seek to match voice biometrics of a single speaker for the purpose of verifying identity. Again, these solutions fail to consider the problem of selecting a single voice from a crowded sound field. Still other solutions seek to distinguish between a human voice and a machine synthesized voice, e.g., by providing visual prompts for a person to read. Once again, these solutions do not address the crowded sound field issue. Finally, some solutions use co-located microphones to direct the view of a camera. These solutions train the camera view on the noisiest thing in the environment, not necessarily the primary speaker.

Accordingly, an embodiment provides a solution in which a primary speaker may be identified using facial recognition technology in combination with audio analysis. For example, an embodiment may detect human faces (e.g., in a camera view) and notice a certain user's lips are moving, especially in a manner consistent with speaking (rather than, say, eating or chewing gum), while another user's lips are not moving (or are not moving in a way associated with speaking) This information, along with audio analysis, e.g., sound field vectors and/or other audio information and analysis, is used to notice where a voice stream is coming from and thereby aid in the detection and identification of the primary speaker, even in a crowed or noisy audio environment. This combination of facial recognition technology with technology that analyzes audio data provides a robust solution to the difficult issue of identifying the current or primary speaker from a group of potential primary speakers.

The illustrated example embodiments will be best understood by reference to the figures. The following description is intended only by way of example, and simply illustrates certain example embodiments.

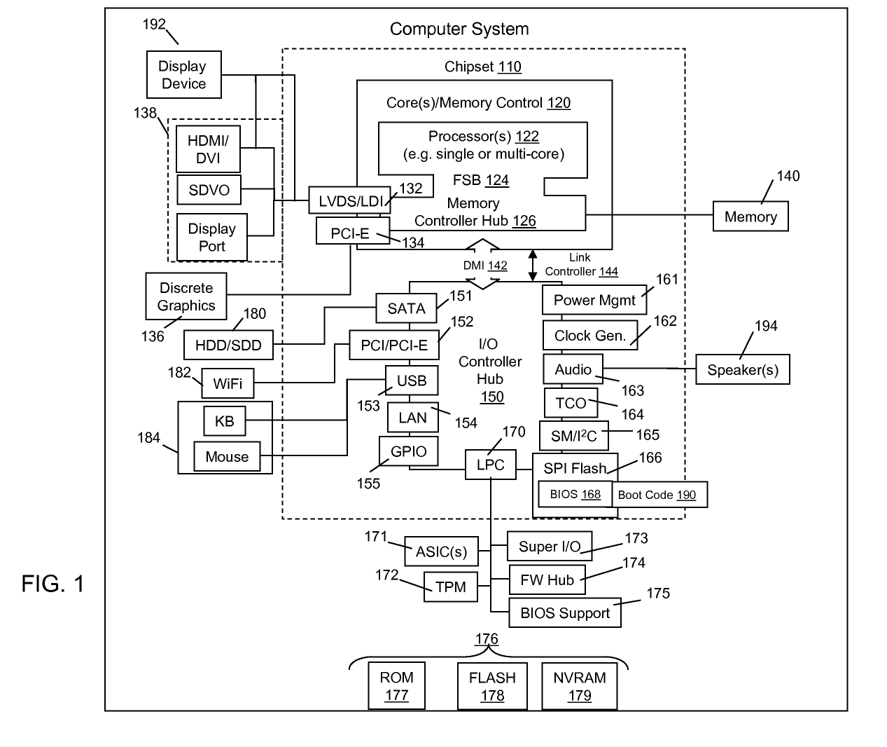

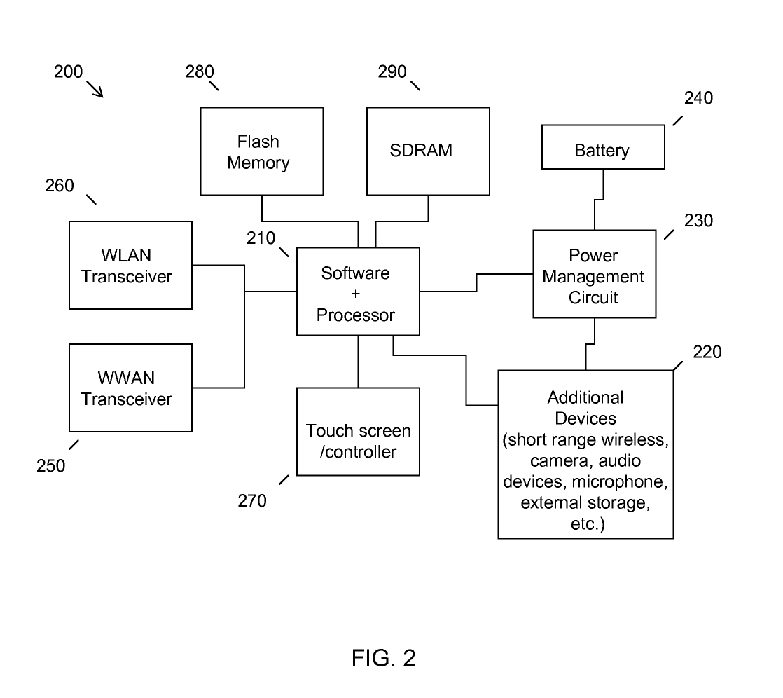

Referring to FIG. 1 and FIG. 2, while various other circuits, circuitry or components may be utilized in information handling devices, with regard to smart phone and/or tablet circuitry 200, an example illustrated in FIG. 2 includes a system on a chip design found for example in tablet or other mobile computing platforms. Software and processor(s) are combined in a single chip 210. Internal busses and the like depend on different vendors, but essentially all the peripheral devices (220) such as a microphone may attach to a single chip 210. In contrast to the circuitry illustrated in FIG. 1, the circuitry 200 combines the processor, memory control, and I/O controller hub all into a single chip 210. Also, systems 200 of this type do not typically use SATA or PCI or LPC. Common interfaces for example include SDIO and I2C.

There are power management chip(s) 230, e.g., a battery management unit, BMU, which manage power as supplied for example via a rechargeable battery 240, which may be recharged by a connection to a power source (not shown). In at least one design, a single chip, such as 210, is used to supply BIOS like functionality and DRAM memory.

System 200 typically includes one or more of a WWAN transceiver 250 and a WLAN transceiver 260 for connecting to various networks, such as telecommunications networks and wireless base stations. Commonly, system 200 will include a touch screen 270 for data input and display. System 200 also typically includes various memory devices, for example flash memory 280 and SDRAM 290.

FIG. 1, for its part, depicts a block diagram of another example of information handling device circuits, circuitry or components. The example depicted in FIG. 1 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 1.

The example of FIG. 1 includes a so-called chipset 110 (a group of integrated circuits, or chips, that work together, chipsets) with an architecture that may vary depending on manufacturer (for example, INTEL, AMD, ARM, etc.). The architecture of the chipset 110 includes a core and memory control group 120 and an I/O controller hub 150 that exchanges information (for example, data, signals, commands, et cetera) via a direct management interface (DMI) 142 or a link controller 144. In FIG. 1, the DMI 142 is a chip-to-chip interface (sometimes referred to as being a link between a “northbridge” and a “southbridge”). The core and memory control group 120 include one or more processors 122 (for example, single or multi-core) and a memory controller hub 126 that exchange information via a front side bus (FSB) 124; noting that components of the group 120 may be integrated in a chip that supplants the conventional “northbridge” style architecture.

In FIG. 1, the memory controller hub 126 interfaces with memory 140 (for example, to provide support for a type of RAM that may be referred to as “system memory” or “memory”). The memory controller hub 126 further includes a LVDS interface 132 for a display device 192 (for example, a CRT, a flat panel, touch screen, et cetera). A block 138 includes some technologies that may be supported via the LVDS interface 132 (for example, serial digital video, HDMI/DVI, display port). The memory controller hub 126 also includes a PCI-express interface (PCI-E) 134 that may support discrete graphics 136.

In FIG. 1, the I/O hub controller 150 includes a SATA interface 151 (for example, for HDDs, SDDs, 180 et cetera), a PCI-E interface 152 (for example, for wireless connections 182), a USB interface 153 (for example, for devices 184 such as a digitizer, keyboard, mice, cameras, phones, microphones, storage, other connected devices, et cetera), a network interface 154 (for example, LAN), a GPIO interface 155, a LPC interface 170 (for ASICs 171, a TPM 172, a super I/O 173, a firmware hub 174, BIOS support 175 as well as various types of memory 176 such as ROM 177, Flash 178, and NVRAM 179), a power management interface 161, a clock generator interface 162, an audio interface 163 (for example, for speakers 194), a TCO interface 164, a system management bus interface 165, and SPI Flash 166, which can include BIOS 168 and boot code 190. The I/O hub controller 150 may include gigabit Ethernet support.

The system, upon power on, may be configured to execute boot code 190 for the BIOS 168, as stored within the SPI Flash 166, and thereafter processes data under the control of one or more operating systems and application software (for example, stored in system memory 140). An operating system may be stored in any of a variety of locations and accessed, for example, according to instructions of the BIOS 168. As described herein, a device may include fewer or more features than shown in the system of FIG. 1.

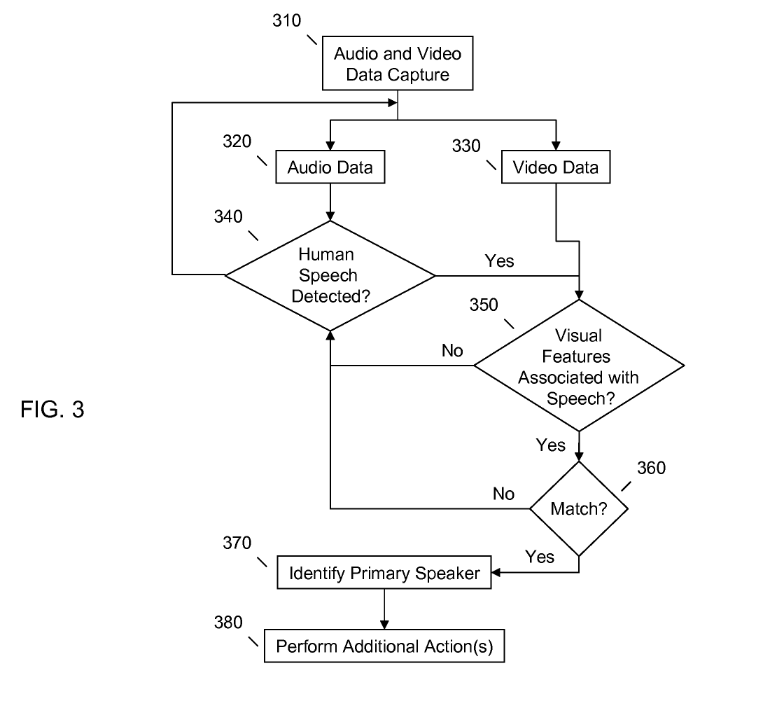

Information handling device circuitry, as for example outlined in FIG. 1 and FIG. 2, may used in connection with the various techniques to identify a primary speaker, as described herein. It should be noted that throughout various non-limiting examples are used for ease of description. In this regard, among others, “camera” is used as an example of a visual sensor, e.g., a camera, an IR sensor, or even an acoustic sensor utilized to form image data. Moreover, “video data” is used as a non-limiting example of image data; however, other forms of data may be utilized, e.g., image data formed from sensors other than a camera, as above. By way of illustrative example, referring to FIG. 3, an example method of primary speaker identification from audio and video data is illustrated.

At a device, e.g., laptop computing device, tablet computing device, etc., audio and visual/video data may be captured at 310. The audio data may be captured or received via a microphone or an array of microphones, for example. The video data may be captured via a camera. For ease of illustration and description, the audio 320 and video data 330 are illustrated and described separately in some portions of this description; however, this is only by way of example. Other like or equivalent techniques may be utilized, e.g., processing combined audio/video data. Moreover, it should be noted that although certain steps are described and illustrated in an example ordering, this is not limiting but rather for ease of description.

In an embodiment, audio data 320 may be analyzed to detect human speech at 340. This may include employment of various techniques or combinations thereof. For example, the audio data 320 may be analyzed using speaker recognition techniques to disambiguate human speech from background noises, including machine produced speech, or may undergo more robust analyses, e.g., speaker identification. More than one speaker may be present in the audio data 320. The presence of more than one speaker in the audio data 320 corresponds to the crowded audio environment and introduces corresponding difficulties, e.g., identifying which, if any, speaker's audio data should be identified as a primary speaker and acted on (e.g., execute commands or queries, etc.).

Accordingly, if an embodiment detects one or more human speakers in the audio data 320 at 340, an embodiment may utilize analysis of the video data 330 to attempt to identify a primary speaker. If no human speech is detected at 340, an embodiment may keep listening and processing an audio signal for recognition of human speaker(s).

The analysis at 350 of the video data 330 may compliment the audio analysis. For example, an embodiment may analyze the video data 330 in an attempt to identify therein visual features, e.g., moving mouth, lips, etc., indicative of a pattern or characteristic associated with speech. If such a pattern is detected at 350, it may then be utilized in making a determination as to which audio data (or portion thereof) it is associated with at 360.

For example, if a pattern of visual features associated with speech is detected at 350, an embodiment may attempt to match at 360 the video data 330 containing the features with the appropriate audio data 330. This may include, by way of example, matching the video data 330 with audio data 320 based on time. Thus, video data 330 (or portion thereof) containing a pattern of visual features associated with speech may contain a time stamp which may be matched with a time stamp of the audio data 320 (or portion thereof).

It should be noted that, similar to using the video data 330 to augment identification of a primary speaker from the audio data 320, the audio data 320 may itself inform or assist in the identification of visual features associated with speech at 350. For example, given beam-forming or directionality information derived from the audio data, e.g., by way of stereo microphones or arrays of microphones, an embodiment may intelligently process the video data 330 in an attempt to identify the visual features or patterns. By way of example, if the audio data 320 contains therein directionality information related to a speaker (e.g., a human speaker is located to the left side of a microphone), this information may be leveraged in the analysis of the video data 330. Such techniques may assist in identification of the visual features or assist in speeding the process thereof, reducing the amount of data to be processed, etc. Timing information generally may be utilized in this regard as well. For example, only processing video data 330 to identify visual features for video data correlated in time with audio data 320 having speaker(s) identified therein. As is apparent, then, an embodiment may provide primary speaker identification in real-time or near real-time.

If there is not a match at 360, an embodiment may either proceed, e.g., using the audio data alone (and thus approximating audio-analysis only systems and performance characteristics) or may cycle back to a prior step, e.g., continued analysis of the audio data 320 and/or video data 330 in an attempt to identify a match.

Responsive to a match at 360, an embodiment may identify a primary speaker at 370. By this it is meant that a primary audio data portion is identified from among a potential plurality of audio data portions. For example, in a crowded audio environment containing more than one speaker, the primary speaker is identified via the matching process outlined above (or suitable alternative matching process utilizing audio and visual data in combination) whereas the other speakers, although perhaps present in audio data 320, are not selected as the primary speaker. Because a primary speaker may be identified at 370, an embodiment is enabled to perform further actions at 380 on the basis thereof. Some illustrative examples follow.

By way of example, in a crowded audio environment where there are two human speakers and a radio playing music (e.g., acting as a source of machine generated speech), an embodiment captures all three audio components as audio data 320 from the environment. An embodiment may also capture video data, e.g., via a camera, as video data 330 for a given time period.

Using audio analysis techniques, e.g., speaker recognition, an embodiment may identify portions of the audio data 320 containing potential human speakers, although it may not be know which is a human speaker and which is machine generated human speech. Thus, an embodiment may look to video data 330, e.g., correlated in time with the portions of the audio data 320 containing the potential speakers, in an attempt to identify visual features associated with speech at 350.

For a portion of audio data 320 which has captured the radio by itself, no visual features will be identified and thus no match will be made at 360. For a portion of audio data 320 in which a human speaker has been captured, with or without the radio, the video data should contain visual features associated with speech. For example, at least one of the human speakers' video data should reveal that their mouth is moving, lips are moving, etc. For such a human speaker, a match may be made between the video data and the audio data at 360, permitting the identification of a primary speaker at 370. Thus, this portion of the audio data 320 may be utilized in processing further actions, e.g., processing commands to a virtual assistant, etc.

For a situation where two speakers provide both audio data 320 and video data 330, an embodiment may disambiguate and identify a primary speaker at 370 via utilization of timing information. For example, for the first match, e.g., audio data having a human speaker recognized along with video data containing visual features associated with speech, a first primary speaker may be identified followed (in time) by identifying another primary speaker, e.g., a subsequent portion of audio data 320 and video data 330 matching. Thus, the primary speaker may be switched, e.g., corresponding to a situation where two or more human speakers take turns talking

Moreover, spatial information may be utilized to disambiguate the primary speaker from among a plurality of human speakers. For example, in lieu of or in addition to use of timing information, directionality information derived from audio data 320, e.g., via an array of microphones, may be utilized to properly identify a primary speaker based on visual features in the video data 330 spatially correlated with the human speech recognized in the audio. Thus, for example, when a speaker is identified and it is determined from the audio data that the speaker is to the left, this may be confirmed/matched to video data 330 containing a speaker identified exhibiting visual features associated with speech in a left portion of a video frame or frames.

In a situation where more than one human speaker provides audio data 320 and video data 330 simultaneously, e.g., two or more people talking at the same time in view of the camera, an embodiment may proceed in one of several ways. For example, an embodiment may simply default to utilizing audio data 320 if the video data 330 is not helpful in disambiguating the primary speaker from the other speaker(s). Alternatively, an embodiment may retain a last known primary speaker (e.g., not permit a switch between primary speakers) until a predetermined confidence level is reached. Thus, a last known primary speaker's audio data may be separated out or isolated from the mixed audio signal (containing more than one speaker) and utilized for performing other actions. In this respect, an embodiment may utilize more robust audio analyses in order to identify the last known primary speaker, e.g., speaker identification analysis. Alternatively or additionally, if multiple simultaneous speakers are present in the audio data 320 and the video data 330, an embodiment may attempt other types of audio analyses in order to disambiguate the audio data and identify a primary speaker at 370. For example, analysis of speech content may be employed to identify the primary speaker from a plurality of simultaneous speakers. This may include matching a speaker's audio to a known list of commands for a virtual assistant. Thus, a primary speaker may be identified from a plurality of speakers with additional speech content analysis to separate speech commands from more random audio input (e.g., discussing the news, etc.).

When a primary speaker has been identified at 370, an embodiment may perform one or more actions on the basis of this identification. For example, a straightforward action may include simply highlighting the identified primary speaker's name in a web conferencing application. Moreover, more complex actions may be completed, e.g., isolating the primary speaker's audio data input form other speakers/noise in order to process the audio input of the primary speaker for action taken by a virtual assistant. Therefore, as will be appreciated from the foregoing, an embodiment may employ knowledge of the primary speaker from a crowded audio field to more intelligently act on audio inputs. This avoids, among other difficulties, processing of inappropriate speech input (e.g., that provided by an out of view speaker such as a nearby co-worker or friend) by a virtual assistant or other audio applications.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Aspects are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving image data from a visual sensor of an information handling device;
receiving audio data from one or more microphones of the information handling device;
identifying, using one or more processors, human speech in the audio data;
identifying, using the one or more processors, a pattern of visual features in the image data associated with speaking;
matching, using the one or more processors, the human speech in the audio data with the pattern of visual features in the image data associated with speaking;
selecting, using the one or more processors, a primary speaker from among matched human speech;
assigning control to the primary speaker; and
performing one or more actions based on audio input of the primary speaker.

2. The method of claim 1, wherein the one or more actions based on the primary speaker identified comprise providing a visual indication of the primary speaker identified.

3. The method of claim 1, further comprising:
processing the matched human speech in a virtual assistant application;
wherein the one or more actions based on the primary speaker identified comprise performing an action via the virtual assistant.

4. The method of claim 3, wherein the action performed via the virtual assistant comprises execution of a command derived from processing the matched human speech.

5. The method of claim 1, further comprising:
activating a virtual assistant of the information handling device responsive to identifying a primary speaker;
wherein the one or more actions based on the primary speaker identified comprises thereafter performing an action via the virtual assistant.

6. The method of claim 1, further comprising:
identifying, using the one or more processors, newly matched human speech as a new primary speaker; and
performing one or more actions based on the new primary speaker identified.

7. The method of claim 1, wherein the receiving audio data from one or more microphones of the information handling device comprises receiving audio data from two or more microphones of the information handling device; and
wherein the identifying a pattern of visual features in the image data associated with speaking comprises utilizing directional information in the audio data received to identify the pattern of visual features associated with speaking.

8. The method of claim 1, wherein the identifying a pattern of visual features in the image data associated with speaking comprises utilizing pattern recognition to identify the pattern of visual features associated with speaking.

9. The method of claim 8, wherein the pattern of visual features in the image data associated with speaking comprise facial movement patterns.

10. The method of claim 9, wherein the identifying a pattern of visual features in the image data associated with speaking comprises filtering out facial movement patterns not associated with speaking.

11. An information handling device, comprising:
a visual sensor;
one or more microphones;
one or more processors; and
a memory storing code executable by the one or more processors to:
receive image data from the visual sensor;
receive audio data from the one or more microphones;
identify human speech in the audio data;
identify a pattern of visual features in the image data associated with speaking;
match the human speech in the audio data with the pattern of visual features in the image data associated with speaking;
select a primary speaker from among matched human speech;
assign control to the primary speaker; and
perform one or more actions based on audio input of the primary speaker.

12. The information handling device of claim 11, wherein the one or more actions based on the primary speaker identified comprise providing a visual indication of the primary speaker identified.

13. The information handling device of claim 11, wherein the code is further executable by the one or more processors to:
process the matched human speech in a virtual assistant application;
wherein the one or more actions based on the primary speaker identified comprise performing an action via the virtual assistant.

14. The information handling device of claim 13, wherein the action performed via the virtual assistant comprises execution of a command derived from processing the matched human speech.

15. The information handling device of claim 11, wherein the code is further executable by the one or more processors to:
activate a virtual assistant of the information handling device responsive to identifying a primary speaker;
wherein the one or more actions based on the primary speaker identified comprises thereafter performing an action via the virtual assistant.

16. The information handling device of claim 11, wherein the code is further executable by the one or more processors to:
identify newly matched human speech as a new primary speaker; and
perform one or more actions based on the new primary speaker identified.

17. The information handling device of claim 11, wherein to receive audio data from one or more microphones of the information handling device comprises receiving audio data from two or more microphones of the information handling device; and
wherein to identify a pattern of visual features in the image data associated with speaking comprises utilizing directional information in the audio data received to identify the pattern of visual features associated with speaking.

18. The information handling device of claim 11, wherein to identify a pattern of visual features in the image data associated with speaking comprises utilizing pattern recognition to identify the pattern of visual features associated with speaking.

19. The information handling device of claim 18, wherein the pattern of visual features in the image data associated with speaking comprise facial movement patterns.

20. A program product, comprising:
a computer readable storage medium storing instructions executable by one or more processors, the instructions comprising:
computer readable program code configured to receive image data from a visual sensor of an information handling device;
computer readable program code configured to receive audio data from one or more microphones of the information handling device;
computer readable program code configured to identify, using one or more processors, human speech in the audio data;
computer readable program code configured to identify, using the one or more processors, a pattern of visual features in the image data associated with speaking;
computer readable program code configured to match, using the one or more processors, the human speech in the audio data with the pattern of visual features in the image data associated with speaking;
computer readable program code configured to select, using the one or more processors, a primary speaker from among matched human speech;
computer readable program code configured to assign control to the primary speaker; and
computer readable program code configured to perform one or more actions based on audio input of the primary speaker.

21. An information handling device, comprising:
a visual sensor;
two or more microphones;
one or more processors; and
a memory storing code executable by the one or more processors to:
receive image data from the visual sensor;
receive audio data from the two or more microphones;
identify human speech in the audio data;
identify a pattern of visual features in the image data associated with speaking utilizing directional information in the audio data received to identify the pattern of visual features associated with speaking;
match the human speech in the audio data with the pattern of visual features in the video data associated with speaking;
identify matched human speech as a primary speaker; and
perform one or more actions based on the primary speaker identified.

22. The information handling device of claim 21, wherein the code is further executable by the one or more processors to:
identify newly matched human speech as a new primary speaker; and
perform one or more actions based on the new primary speaker identified.
